(19) United States
(12) Patent Application Publication
(10) Pub. No.: US 2018/0131249 A1
(43) Pub. Date: May 10, 2018

(54) ELECTRIC MACHINE

(71) Applicant: Valeo Systemes de Controle Moteur, Cergy Saint Christophe (FR)

(72) Inventors: Franck Giraud, Cergy Saint Christophe (FR); Jean-Philippe Badey, Cergy Saint Christophe (FR)

(73) Assignee: Valeo Systemes de Controle Moteur, Cergy Saint Christophe (FR)

(21) Appl. No.: 15/534,785

(22) PCT Filed: Dec. 11, 2015
(86) PCT No.: PCT/FR2015/053445

§ 371 Date: Oct. 12, 2017

(30) Foreign Application Priority Data
Dec. 11, 2014 (FR) 1462272

(51) Int. Cl. H02K 5/24; F02B 39/10

(52) U.S. Cl. CPC H02K 5/24; F02B 39/10

(57) ABSTRACT

The present invention relates to an electric machine, including at least one stator (2), and noise reduction means comprising at least acoustic insulation means (61′, 61″) of the stator (2) with respect to the rest of the electric machine (1).

The present invention relates to the field of electric machines, and more particularly relates to electric machines for an electric compressor, and for example an electric supercharger compressor.

An electric machine is a machine, also called motor, that includes at least one stator. The stator includes teeth around which the coils are wound. Supply power to each of the coils makes it possible to create a magnetic field in the stator, a rotor being oriented along the field lines.

In the automotive field, these electric machines are for example used in electric compressors. For example, these machines are used in the air intake circuit to improve the performance of the vehicle, offset the lag phase of the traditional turbocompressor upon startup, or in the transitional phases of the vehicle.

However, this type of machine is a source of noise. Indeed, the vibrations from the motor can interfere with the resonance frequency of the machine and create additional vibrations as well as high-frequency micro-movements in the audible range of the human ear. The vibrations are transmitted over the entire structure of the machine, and propagate in the air and in the supports of the machine. While the noise conducted by the machine toward the support can be reduced by shock absorbers, the noise intrinsic to the machine is more difficult to address.

One solution to this noise consists of reducing the effects of radial forces. The effects of radial forces are reduced, for example, by arranging recesses in the material on the outer face of the stator, in the extension of the teeth of the stator. Such a solution allows a gain in terms of deformation, making it possible to reduce the radial forces on the part in contact with the stator. This gain participates in the partial reduction of the noise, which thus remains audible to the human ear.

The present invention therefore aims to offset one or several of the drawbacks of the machines of the prior art by proposing an electric machine configured to limit noise annoyance.

To that end, the present invention proposes an electric machine, including at least one stator, and noise reduction means comprising at least acoustic insulation means of the stator with respect to the rest of the electric machine.

Indeed, it has been shown that using axial acoustic insulation means 61′, 61″ makes it possible to reduce noise annoyance by at least 15 dB.

According to one embodiment, the acoustic insulation means are axial insulation means.

According to one embodiment of the invention, the axial insulation means are formed by at least two seals positioned at the axial ends 610 of the stator.

According to one embodiment of the invention, at least one portion of the seal is compressed with the surface of the end of the stator.

According to one embodiment of the invention, the number of compressed portions is determined as a function of the mass of the stator.

According to one embodiment of the invention, the compression portion is produced by the seal itself.

According to one embodiment of the invention, the compression portion is produced by an additional part that locally compresses certain zones of the seal.

According to one embodiment of the invention, the machine includes radial thermal dissipation means that are formed by resin covering at least part of the outer radial surface of the stator.

The invention also relates to the use of the electric machine according to the invention in an electric supercharger compressor for a motor vehicle.

The invention also relates to an electric supercharger compressor equipped with an electric machine according to the invention.

Other aims, features and advantages of the invention will be better understood and will appear more clearly upon reading the description provided below, in reference to the appended figures, given as examples and in which:

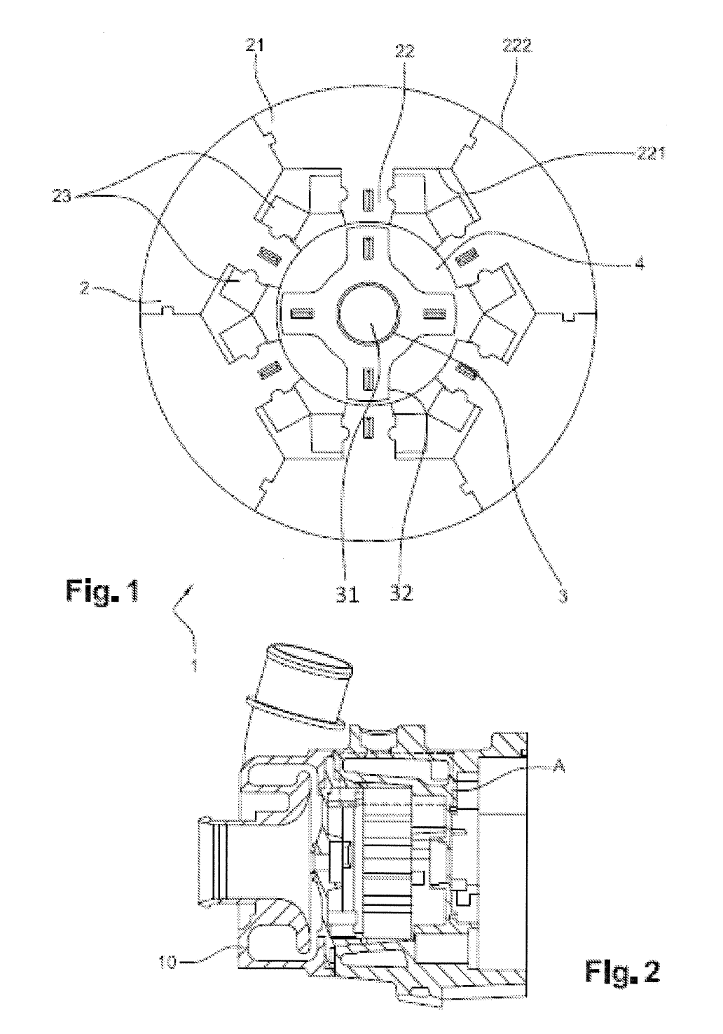

FIG. 1 is a schematic cross-sectional illustration of the device according to the present invention,

FIG. 2 is a schematic longitudinal sectional illustration of the device according to the invention integrated into an electric compressor,

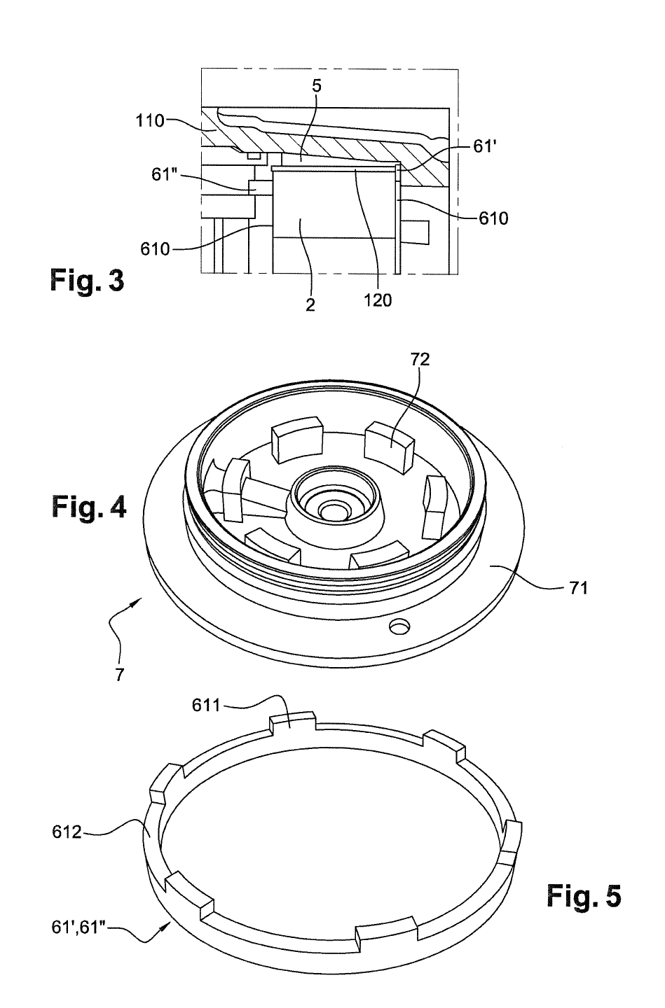

FIG. 3 is a schematic illustration of detail A of FIG. 3 according to the invention,

FIG. 4 is a schematic illustration of the additional part according to the invention,

FIG. 5 is a schematic illustration of an alternative of an axial acoustic insulation means according to the invention.

The present invention relates to an electric machine 1. The electric machine 1 includes at least one stator 2, illustrated in FIGS. 1 and 3. The electric machine also includes a rotor 3 positioned inside the stator 2. More specifically, the rotor 3 is positioned in a space 4 formed at the center of the stator 2.

According to one embodiment of the invention, the stator is positioned in a recess formed in the body 110 of the electric machine, illustrated in FIG. 3.

According to one embodiment of the invention, the electric machine is a DC or AC, synchronous machine, or any type of electric machine of the same type.

According to one embodiment of the invention, the electric machine is a switched reluctance motor (SRM).

According to one embodiment of the invention, the electric machine is a permanent magnet motor.

The stator 2 is formed by at least one body 21. According to one embodiment of the invention, the stator is a single piece. According to one embodiment of the invention, the stator is formed by several parts. The stator is also formed by several teeth 22. The teeth are positioned on the inner face 221 of the body of the stator defining the space 4 in which the rotor is found. The stator 2 includes n teeth 22, n being greater than or equal to 4, preferably comprised between 4 and 20, preferably between 4 and 12, and very preferably equal to 6. Around each of the teeth 22, a winding is positioned that thus forms the coils 23 of the stator. Supplying power to each of the coils 23 allows the creation of a magnetic field in the stator 2.

According to one embodiment of the invention, the rotor 3 includes rotor teeth 32 oriented along the field lines of the stator 2. The number of rotor teeth 3 is comprised between 2 and 8, and is preferably equal to 4.

In the context of the invention, the noise reduction means comprise acoustic insulation means of the stator relative to the rest of the electric machine.

According to one embodiment of the invention, it has been shown that using axial acoustic insulation means 61′, 61″ makes it possible to reduce the noise annoyance by 15 dB.

According to another embodiment of the invention, the axial acoustic insulation means 61′, 61″ are formed by at least two seals 61′, 61″ positioned at the radial ends 610 of the stator 2. The axial end 610 of the stator corresponds to the two outer surfaces of the stator 2 positioned perpendicular relative to the axis 31 of the stator 2.

In the context of the invention, the longitudinal axis 31 of the stator is defined as being the axis 31 along which the stator extends, passing through the center of the stator, i.e., the axis 31 around which the stator is positioned and the rotation axis of the rotor.

According to one embodiment of the invention, the seals 61′, 61″ are elastomer seals. For example, the seals are of the fluoroelastomer (FKM, FKM peroxide), hydrogenated nitrile butadiene rubber (HNBR) of ethylene-propylene-diene monomer (EPDM) type.

According to one embodiment of the invention, the seals 61′, 61″ are positioned on the periphery of the surface 610 forming the ends of the stator 2.

According to one embodiment of the invention, at least one portion of the seal 61′, 61″ is compressed with the surface 610 of the end of the stator. According to one embodiment of the invention, several portions of the seal 61′, 61″ are compressed with the surface of the end of the stator. In fact, it has been shown that the noise reduction was greater when certain zones of the seal are compressed on the surface of the end of the stator.

In the context of the invention, a compressed portion refers to a compression point of the seal against the surface 600 of the end of the stator. In other words, the contact pressure of this zone is greater than that of the other contact zones of the seal with the surface of the end of the stator.

According to one embodiment of the invention, the number of compression portions is determined as a function of the mass of the stator. In other words, the higher the mass, the more necessary it may be to have points of contact.

According to one embodiment of the invention, at least six portions of the seal 61′, 61″ are compressed with the surface of the end of the stator.

According to one embodiment of the invention, at least eight portions of the seal 61′, 61″ are compressed with the surface 610 of the end of the stator.

According to one embodiment of the invention, between 1, i.e., a complete crown 612 of the seal, and 30 portions of the seal 61′, 61″ are compressed with the surface 610 of the end of the stator.

According to one embodiment of the invention illustrated in FIG. 5, the compression portion is produced by the seal 61′, 61″ itself. In other words, the seal has raised elements 611 allowing greater contact with the surface 160 of the end of the stator 2. The raised elements 611 are protuberances that all have shapes making it possible to ensure contact with the surface of the end of the stator. For example, the raised elements have bump, cone or planar shapes.

According to one embodiment of the invention illustrated in FIG. 4, the compression portion is produced by a complementary part 7 that locally compresses certain zones of the seal 61′, 61″. More specifically, the complementary part 7 presses the seal 61′, 61″ against the end surface 160 of the stator 2. The pressing is done more strongly in certain zones, which are the compression portions.

According to one embodiment of the invention, the complementary part 7 is a circular part 71 whose diameter is suitable for the part to cooperate with the seal 61′, 61″.

According to one embodiment of the invention, the complementary part 7 includes raised zones 72. It is these zones 72 which, when the complementary part 7 is pressed against the seal 61′, 61″, exert complementary pressure in certain zones of the seal and produce the compression points. The raised zones are for example bumps, cones or planar zones.

According to one embodiment of the invention, the complementary part 7 is made from aluminum.

According to one embodiment of the invention, the complementary part 7 is any part making it possible to produce these compression points.

In the context of the invention, the electric machine 1 includes heat transfer means 5. More specifically, the heat transfer means 5 are radial heat dissipating means.

According to one embodiment of the invention, the heat dissipating means 5 are formed by resin covering the outer radial surface of the stator 2.

In the context of the invention, the radial surface of the stator is the outer face 222 of the stator 2. This is the face that does not include teeth 22 and is positioned outside the stator 2 if the inner face 221 of the stator is considered to define a zone 4 of the stator 2 in which the rotor 3 is positioned.

According to one embodiment of the invention, the resin 5 completely fills in the empty space between the radial surface of the stator 2 and the body 110 of the electric machine 1.

According to one embodiment of the invention, the resin fills in part of the empty space between the radial surface of the stator 2 and the body 110 of the electric machine 1. More specifically, one or several portions of the empty space are filled in by the resin.

According to one embodiment of the invention, the hardness and the shock absorption coefficient of the resin are chosen such that it does not interfere with the radial forces, so as not to increase the noise caused by the machine, but so that it allows a sufficient heat transfer. Indeed, it is important for the heat from the electric machine not to be stored in the electric machine, but to be dissipated to the outside. This avoids any overheating of the machine, and in particular its electronic system.

According to one embodiment of the invention, the resin is a flexible resin.

According to one embodiment of the invention, the resin has a hardness less than or equal to 80 shore A, preferably less than or equal to 60 shore A, very preferably less than or equal to 40 shore A.

According to one embodiment of the invention, when the stator 2 is formed by several parts, the electric machine includes an aluminum ring 120 positioned between the stator 2 and the resin 5.

Such an electric machine according the invention allows a gain of 5 to 15 dB depending on the rotation ratings of the motor of the vehicle in which the machine is used. The noise emitted by the electric machine is thus no longer considered noise annoyance for the human ear.

The invention also relates to the use of such a machine according to the invention in an electric supercharger compressor 10 for a motor vehicle.

The invention also relates to an electric supercharger compressor 10 equipped with such a machine 1 according to the invention. More specifically, the invention also relates to an electric compressor 10 equipped with a switched reluctance motor according to the invention.

The scope of the present invention is not limited to the details given above and allows embodiments in many other specific forms without going beyond the scope of application of the invention. Consequently, these embodiments must be considered as an illustration, and can be modified without going beyond the scope defined by the claims.

1. An electric machine, comprising:
at least one stator; and
noise reduction means comprising at least acoustic insulation means of the stator with respect to the rest of the electric machine.

2. The electric machine according to claim 1, wherein the acoustic insulation means are axial insulation means.

3. The electric machine according to claim 2, wherein the axial insulation means are formed by at least two seals positioned at the axial ends of the stator.

4. The electric machine according to claim 3, wherein at least one portion of the seal is compressed with the surface of the end of the stator.

5. The electric machine according to claim 4, wherein a number of compressed portions is determined as a function of the mass of the stator.

6. The electric machine according to claim 4, wherein the compression portion is produced by the seal itself.

7. The electric machine according to claim 4, wherein the compression portion is produced by an additional part that locally compresses certain zones of the seal.

8. The electric machine according to claim 1, further comprising radial thermal dissipation means that are formed by resin covering at least part of the outer radial surface of the stator.

9. A use of the electric machine according to claim 1 in an electric supercharger compressor for a motor vehicle.

10. An electric supercharger compressor equipped with an electric machine according to claim 1.
